(19) United States
(12) Patent Application Publication
(10) Pub. No.: US 2002/0070649 A1
(43) Pub. Date: Jun. 13, 2002

(54) Traffic lamp and filaments therefor

(76) Inventor: Raghunatha S. Rao, Darien, IL (US)

Correspondence Address: SEYFARTH SHAW, 55 EAST MONROE STREET, SUITE 4200, CHICAGO, IL, 60603-5803, US

(21) Appl. No.: 09/733,467

(22) Filed: Dec. 8, 2000

(51) Int. Cl. H01K 1/58

(52) U.S. Cl. 313/315; 313/25; 313/37; 313/271

(57) ABSTRACT

A traffic lamp has a helical coil filament arranged in a pattern with no angles or sharp bends and with each convolution of the coil substantially tangent to the focal plane of the lamp. The filament may be generally in the pattern of the lower case Greek letter Omega and is supported on seven support wires, so that the same filament length can be used for both 120-volt and 240-volt applications. In one embodiment, the lamp has two filaments arranged as arcs of a common circle lying substantially in the focal plane, each arc being supported on three support wires, the filaments being respectively connected in series with diodes so that the filaments respectively conduct on alternate half cycles of the AC source voltage.

### BACKGROUND

This application relates to lamp constructions and, in particular, to incandescent lamps and the filament arrangements therefore. The application relates specifically to traffic lamps, although principles disclosed herein may be more generally applicable to other types of incandescent lamps.

Traffic signals are designed to withstand environments with a high degree of vibration. Thus, the filament for an incandescent traffic signal lamp is supported on a plurality of supports, the number of supports varying with the overall length of the filament, which may vary with the voltage of the particular application. It has become standard practice in the industry, for example, to provide lamps for traffic signal applications with five supports for use with 120-volt filaments and nine supports for use with 230/240-volt filaments. Typically, the filaments are helically coiled, electrically conductive wires, which may be arranged in a variety of different shapes or patterns, depending upon the application. Existing traffic lamp filament mounting arrangements typically result in a filament pattern with one or more sharp bends or angles which intersects the focal plane of the lamp, extending on both sides of that plane. Such arrangements commonly cause irregular beam patterns and also can result in hot spots, where adjacent convolutions of the filament coil come too close together at locations leading into and out of sharp bends in the filament pattern. Such hot spots, in addition to contributing to irregular beam patterns, tend to reduce the useful life of the filament.

### SUMMARY

This application describes an improved traffic lamp and filament arrangement therefore which avoids disadvantages of prior lamps and filaments arrangements, while affording additional structural and operating advantages.

An important aspect is the provision of a lamp with improved vibration resistance.

Another aspect is the provision of a lamp of the type set forth, which has a filament with improved useful life.

In connection with the foregoing aspect, a further aspect is the provision of a lamp of the type set forth which minimizes the occurrence of hot spots in the filament.

Another aspect is the provision of a lamp of the type set forth, with a filament which has the same filament length for voltages ranging from 800 volts to 240 volts.

Another aspect is the provision of a lamp of the type set forth, which provides a filament disposed substantially in the focal plane of the lamp along the entire length of the filament.

Certain ones of these and other aspects may be attained by providing an incandescent lamp comprising a base defining electrical terminals, a bulb coupled to the base, a filament support assembly disposed within the bulb, and a filament disposed within the bulb and carried by the support assembly and connected to the terminals, the filament being arranged to define a continuously curved pattern which has no sharp bends or angles and which extends substantially parallel to a plane.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a side elevational view of a lamp embodiment;

FIG. 2 is an enlarged, top plan view of the filament assembly taken generally along the line 2-2 in FIG. 1;

FIG. 3 is a further enlarged, fragmentary, sectional view taken generally along the line 3-3 in FIG. 2;

FIG. 4 is a fragmentary view similar to FIG. 1, of another lamp embodiment;

FIG. 5 is a view similar to FIG. 2, showing the filament assembly of FIG. 4; and

FIG. 6 is a schematic circuit diagram of the lamp of FIG. 4.

### DETAILED DESCRIPTION

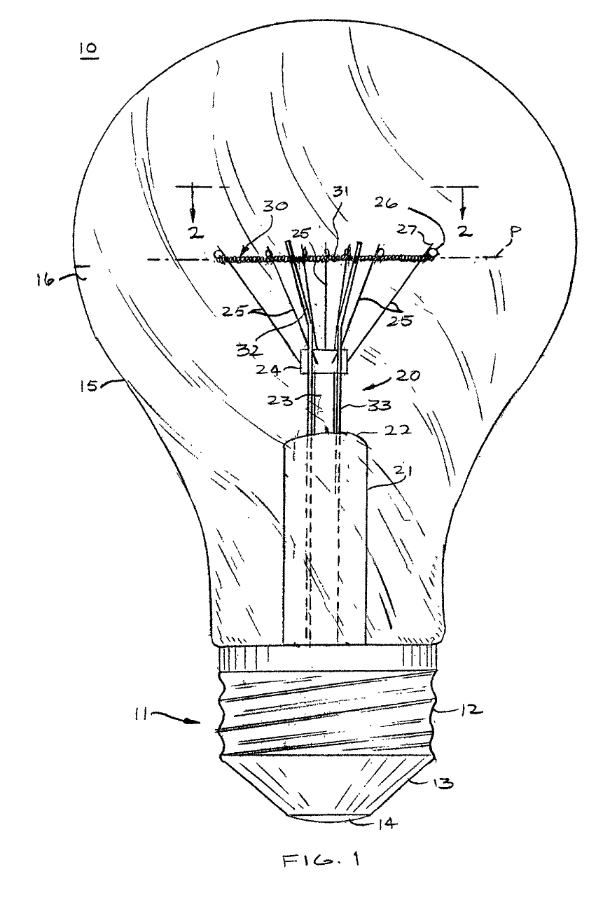

Referring to FIG. 1, there is illustrated a traffic lamp, generally designated by the numeral 10, having a base 11 with an externally threaded metallic side wall 12, a frustoconical electrically insulating portion 13, and an electrically conductive bottom terminal button 14, all of known construction. The base 11 is coupled to a bulb 15, typically formed of transparent glass and defining therein an evacuated chamber 16, all in a known manner.

Disposed in the chamber 16 is a filament support assembly 20, which includes a tubular glass column 21, which is coaxial with the bulb 15 and may be continuous therewith and has a closed top 22. Extending axially from the top 22 is a post 23 integral at its distal end with a cylindrical head flange 24. Extending radially outwardly and axially forwardly from the head flange 24 are a plurality of circumferentially spaced-apart support wires 25, each bent adjacent to its distal end into a single loop 26 with a short tail 27.

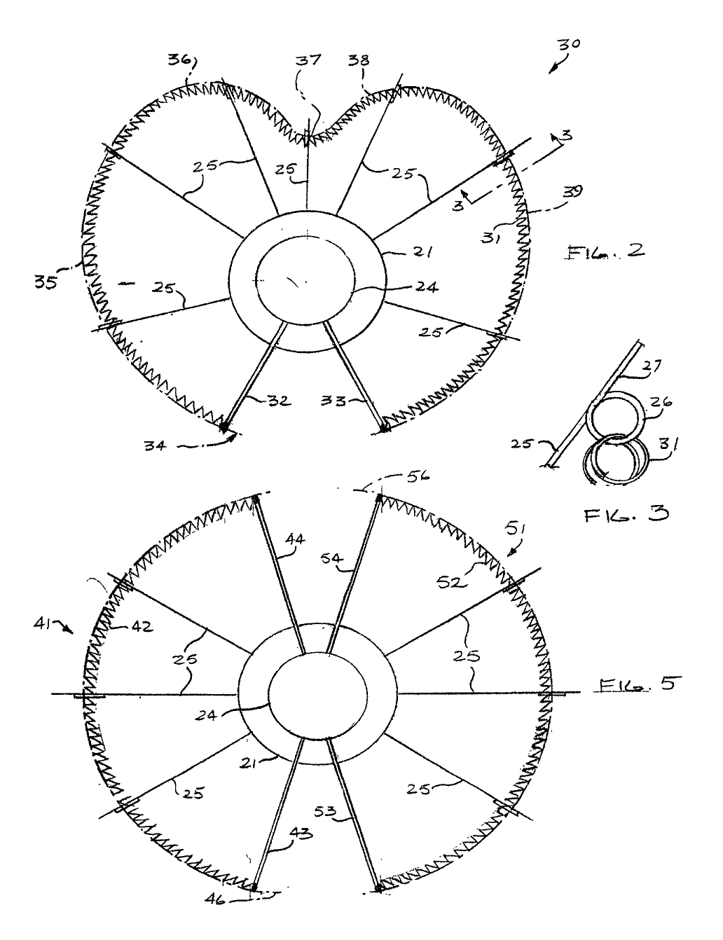

Referring also to FIGS. 2 and 3, the filament support assembly 20 supports a filament 30, which is a helical coil 31 of an electrically conductive wire formed of a suitable metal which will incandesce when heated with an electric current, in a known manner. The filament 30 has ends which are respectively electrically connected by suitable means to leads 32 and 33, which extend downwardly through the tubular column 21 for connection, respectively, to the threaded side wall 12 and the bottom terminal button 14 of the base 11, which form the connection terminals of the lamp 10 in a known manner. It is a significant aspect of the invention that the filament 30 is arranged in a continuously curved pattern, shown in FIG. 2, which is devoid of angles or sharp bends, so that adjacent convolutions of the coil 31 will maintain a substantially uniform spacing and not be brought so close together as to create hot spots in the filament. In the illustrated embodiment, the filament 30 is generally in the shape of the lower case Greek letter Omega, having a large-radius arc 35, an intermediate-radius arc 36, a relatively small-radius arc 37, an intermediate-radius arc 38 and a large-radius arc 39.

The filament 30 is supported in the loops 26 of the support wires 25, as shown in FIG. 3, each loop 26 being at least 360° with a projecting tail 27 to ensure that the filament 30 cannot accidentally fall off of the support wire 25. The loops 26 are positioned so that the filament 30, in its supported condition illustrated in FIGS. 1 and 2, has the convolutions of the coil 31 all tangent to an imaginary line 34 which outlines the overall shape of the filament 30 and lies in a plane, which may be the focal plane P (FIG. 1) of the lamp 10. This will facilitate production of a uniform beam pattern with no hot spots, thereby maximizing the useful life of the filament 30. It has been found that, with this arrangement, the filament 30 can effectively be supported by the leads 32 and 33 and seven support wires 25. It has also been found that this arrangement permits the mounting of both medium-voltage filaments for voltages in the range of about 100 volts to about 130 volts, and high-voltage filaments for use with voltages in the range of about 220 volts to about 250 volts, with the same filament length, eliminating the need for different-shaped support assemblies for different voltage applications.

Referring now to FIGS. 4-6, there is illustrated another embodiment of traffic lamp, generally designated by the numeral 40, which is similar to the lamp 10 except for the filament pattern, so that parts which are the same in the two embodiments bear the same reference numbers. The lamp 40 has two filaments 41 and 51 which are substantially mirror images of each other. More particularly, the filament 41 comprises a helical coil 41 of suitable filament wire having opposite ends respectively connected to leads 43 and 44, while the filament 51 comprises a coil 52 having the ends thereof connected to leads 53 and 54. The leads 43, 44, 53 and 54 all extend downwardly into the base 11 in the manner described above, both of the leads 44 and 54 being connected to the threaded side wall 12 of the base 11, which forms a terminal 58 (see FIG. 6). However, the leads 43 and 53 are connected to the bottom terminal button 14, which forms a terminal 59 (FIG. 6), respectively through diodes 45 and 55. More particularly, the lead 43 is connected to the cathode of the diode 45, the anode of which is connected to the terminal 59, while the lead 53 is connected to the anode of the diode 55, the cathode of which is connected to the terminal 59.

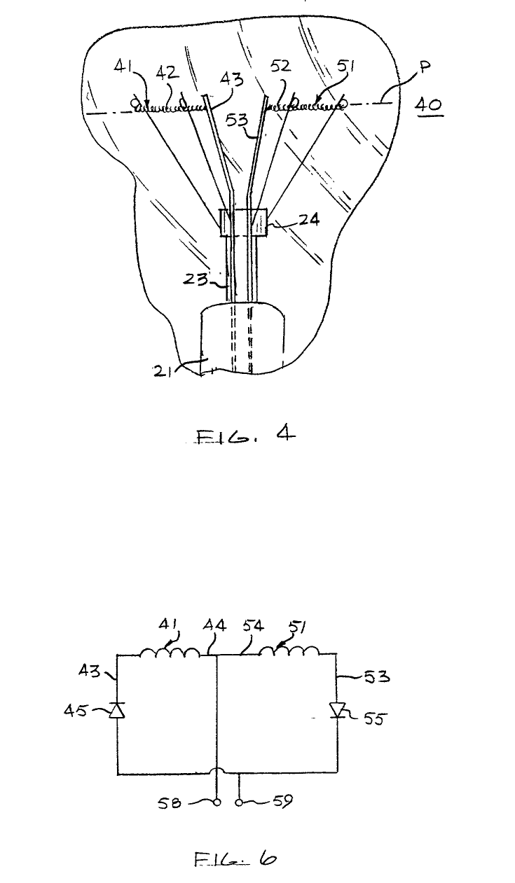

As can be seen in FIG. 5, the filaments 41 and 51 are arranged so that the convolutions of the coils 42 and 52 are tangent to continuously curved imaginary arcs 46 and 56, respectively, which form arcs of the common circle which lies in the focal plane P of the lamp 10 (see FIG. 4). Each filament 41, 51 can be supported by three support wires 25 and the associated leads. This continuously curved arrangement, without angles or sharp bends, avoids hot spots and provides a substantially uniform beam pattern for reasons explained above. However, in this case, the vibration resistance and useful life of the filaments 41 and 51 are further enhanced, because this arrangement permits lower-voltage, i.e., heavier gauge filaments to be used. Normally, the use of a rectifying diode with a single filament reduces voltage and improves useful life, but at the cost of reduced light output and a flickering effect (because the filament is “on” for only one-half of each cycle of the AC source voltage). The use of two filaments eliminates these problems, the diodes 45 and 55 being reverse connected so that the filaments 41 and 51 are, respectively, conducting during alternate half cycles of the AC source voltage, so that at least one filament is always on. Thus, the lamp can operate with a power factor of 1, just as in the case of a single-filament lamp 10, described above. The use of two filaments also provides a safety factor in the event that one filament should fail, the other filament continuing to produce a usable (although reduced) light output, allowing additional time for replacement of the traffic lamp.

The matter set forth in the foregoing description and accompanying drawings is offered by way of illustration only and not as a limitation. While particular embodiments have been shown and described, it will be obvious to those skilled in the art that changes and modifications may be made without departing from the broader aspects of applicants' contribution. The actual scope of the protection sought is intended to be defined in the following claims when viewed in their proper perspective based on the prior art.

I claim:

1. An incandescent lamp comprising:
a base defining electrical terminals,
a bulb coupled to the base,
a filament support assembly disposed within the bulb, and
a filament disposed within the bulb and carried by the support assembly and connected to the terminals,
the filament being arranged to define a continuously curved pattern which has no sharp bends or angles and which extends substantially parallel to a plane.

2. The lamp of claim 1, wherein the filament is in the form of a helical coil of wire.

3. The lamp of claim 1, wherein the support assembly includes a plurality of support wires defining loops encircling the filament, respectively at spaced-apart locations therealong.

4. The lamp of claim 1, wherein the filament is arranged generally in the shape of the lower case Greek letter omega (ω).

5. The lamp of claim 4, wherein the support assembly includes seven support wires coupled to the filament in supporting relationship therewith at spaced-apart locations therealong.

6. The lamp of claim 1, wherein the filament is arranged in the shape of a continuous arc of substantially constant radius.

7. The lamp of claim 6, wherein the support assembly includes three support wires coupled to the filament in supporting relationship therewith at spaced-apart locations therealong.

8. The lamp of claim 1, wherein the plane is the focal plane of the lamp.

9. An incandescent lamp comprising:
a base defining electrical terminals,
a bulb coupled to the base,
a filament support assembly disposed within the bulb, and
two filaments disposed within the bulb and carried by the support assembly and connected to the terminals,
each filament being arranged to define a continuously curved pattern which has no sharp bends or angles and which extends substantially parallel to a plane.

10. The lamp of 9, and further comprising two diodes respectively connected in series with the filaments.

11. The lamp of claim 10, wherein the diodes are respectively connected between the filaments and the terminals, so that the filaments respectively conduct during opposite half cycles of an AC source voltage.

12. The lamp of claim 9, wherein the two filaments lie substantially in the same plane.

13. The lamp of claim 12, wherein the plane is the focal plane of the lamp.

14. The lamp of claim 9, wherein each filament is in the form of an elongated helical coil of wire.

15. The lamp of claim 9, wherein the filament support assembly includes a plurality of support wires disposed in supporting relationship with the filament at spaced-apart locations therealong.

16. The lamp of claim 15, wherein each filament has three support wires coupled thereto.

17. The lamp of claim 9, wherein the two filaments respectively define arcs of a common circle.

18. A filament for an incandescent lamp, the filament comprising:
an elongated helical coil of electrically conducting wire,
the coil being arranged so that each convolution thereof is tangent to an imaginary continuously curved line having no sharp bends or angles and lying in a plane.

19. The filament of claim 18, wherein the filament is arranged generally in the shape of the lower case Greek letter omega (ω).

20. The filament of claim 18, wherein the filament is arranged in the shape of a continuous arc of substantially constant radius.
